(19) United States
(12) Patent Application Publication
(10) Pub. No.: US 2004/0053121 A1
(43) Pub. Date: Mar. 18, 2004

(54) Method and an apparatus for providing an identity marking on an object

(76) Inventors: Pavlo Malushevskyy, Nikolaev (UA); Volodymyr Ryabtsev, Dnepropetrovsk (UA); Malvin Hoeydal, Aalgaard (NO); Tatiana Hoeydal, Aalgaard (NO)

Correspondence Address: Steven S. Payne, 8027 ILIFF Drive, Dunn Loring, VA, 22027, US

(21) Appl. No.: 10/419,778

(22) Filed: Apr. 22, 2003

(30) Foreign Application Priority Data
Oct. 23, 2000 (EP) 10438

(51) Int. Cl. H01M 4/36

(52) U.S. Cl. 429/101

(57) ABSTRACT

A method and an apparatus are presented for providing an identity marking on an object (2) made of an electrically conductive material with crystalline structure. A plurality of areas is selected on a surface of the object. For each selected area, an electrode (5) is positioned in proximity with the selected area. A fluid is supplied between the electrode and the selected area, and an electrical impulse is generated between the electrode and the selected area through the fluid. In response, a plasma channel is formed, wherein a structural material change occurs locally at each selected area. The identity marking of the object is represented by the selected areas with their structural material change.

### TECHNICAL FIELD

Generally speaking, the present invention relates to identity marking of objects made of electrically conductive material with crystalline structure. In particular, the present invention relates to a method and an apparatus for providing such identity marking on various objects made of carbon-contained steels and alloys, such as pipes, tools, spare parts and other constructions used in the petroleum industry, gas industry, heavy industry, car industry, etc.

### PRIOR ART

Steel pipes are a representative example of the objects referred to above. Steel pipes are heavily used in different industrial areas, such as the petroleum and gas industries. For the rest of this specification, a steel pipe will be referred to as an example of an object, which may be provided with an identity marking according to the method and apparatus of the present invention. However, it is to be emphasized that the present invention is not limited to steel pipes but may be applied to virtually any type of object made of an electrically conductive material having a crystalline structure.

Various methods of providing an identity marking to steel pipes and other constructions are previously known. These methods include stencil painting on the surface of the steel object, gluing a coded label onto the object, implanting an electronic transponder in the object, engraving an identity marking by a laser beam on the surface of the object, etc. These known methods have different drawbacks. For instance, an identity marking which is painted on the surface of the object, or is glued onto the surface in the form of a label, may accidentally be partly or entirely destroyed during the rough handling, which the object may be exposed to during its lifetime. Electronic transponders contain sensitive electronic circuitry, which may be damaged or otherwise cease to function properly during the lifetime of the object.

GB-A-2 340 640 discloses a method of storing binary information on a crystalline material, such as a shape memory alloy. A laser beam or electron beam irradiates the surface of the material in a predetermined pattern. Individual crystals are heated to the extent that a structural change occurs in each crystal, wherein the changed crystals will represent the information stored on the material. The stored information may subsequently be read by scanning the surface of the material with an electron beam or a laser, analyzing the reflection from the surface and decoding the information.

The method of GB-A-2 340 640 has a drawback in that the structural modification of the material is limited to individual crystals at the surface layer of the material. Thus, if the material is subjected to rough handling (such as the ordinary handling of a steel construction used in any of the industrial areas referred to above), the modified surface layer is likely to be damaged, which will render the information stored therein unreadable. Moreover, the fact that the modification occurs for individual crystals makes the method applicable only to certain appropriate materials, e.g. shape memory alloys. Additionally, advanced high-precision equipment is required in order to produce the extremely localized heat generation so as to change the structure of the individual crystals.

### SUMMARY OF THE INVENTION

It is an objective of the present invention to provide improved identity marking of steel constructions and other objects made of an electrically conductive material with a crystalline structure. More specifically, the present invention aims at providing an identity marking, which is of high quality, has permanent duration and has a high resistance to external forces, e.g. abrasive wear. Moreover, it is an object of the invention to provide a flexible identity marking, which allows the identity to be stored in an arbitrary format and represent arbitrary information.

From an overall point of view the above objectives have been achieved by the following inventive understandings. The identity marking of the object may be represented by a plurality of zones at a surface region of the object, where the material structure of these zones are changed locally by applying a high-voltage electrical impulse between an electrode and the surface of the object through a working fluid. The electrical impulse creates a channel of plasma (a stream of highly concentrated energy) through the working fluid, which will enter as energy into the surface region of the object. The material structure of the object is locally changed by this energy, wherein the modified zones will be strengthened (hardened) compared to the original structure of the material. Additionally, the chemical composition and/or the mechanical properties may be different for the modified zones compared to the original material.

The modified zones may be subsequently detected by measuring arrangements known per se. Advantageously, the identity marking may be represented by a plurality of modified zones together with intermediate unmodified areas, wherein the modified zones may represent a first type of digit (e.g. a logical 1) in a binary code, whereas the unmodified zones will represent the opposite type of binary digit (e.g. a logical 0).

The objectives above are achieved by a method and an apparatus according to the enclosed independent patent claims. Other objectives, features and advantages of the present invention will appear from the following detailed disclosure, from the attached drawings as well as from the dependent claims.

### BRIEF DESCRIPTION OF THE DRAWINGS

Preferred and alternative embodiments of the present invention will now be described in more detail with reference to the accompanying drawings, in which:

FIG. 1 is a schematic illustration of an apparatus for providing identity marking on an object according to a preferred embodiment of the invention,

FIG. 2 is a more detailed illustration of a portion of FIG. 1,

FIG. 3 is a flowchart diagram, which illustrates the method according to the invention,

FIG. 4 is a graph illustrating the surface hardness of an object having been provided with an identity marking according to the invention,

FIG. 5 is a graph illustrating the residual stress of an object having been provided with an identity marking according to the invention,

FIG. 6 is a graph illustrating the micro deformations of an object having been provided with an identity marking according to the invention,

FIG. 7 is a graph illustrating the cracking resistance of an object having been provided with an identity marking according to the invention, and

FIG. 8 is an illustration of an exemplifying binary-coded identity marking according to the invention.

### DETAILED DISCLOSURE OF THE INVENTION

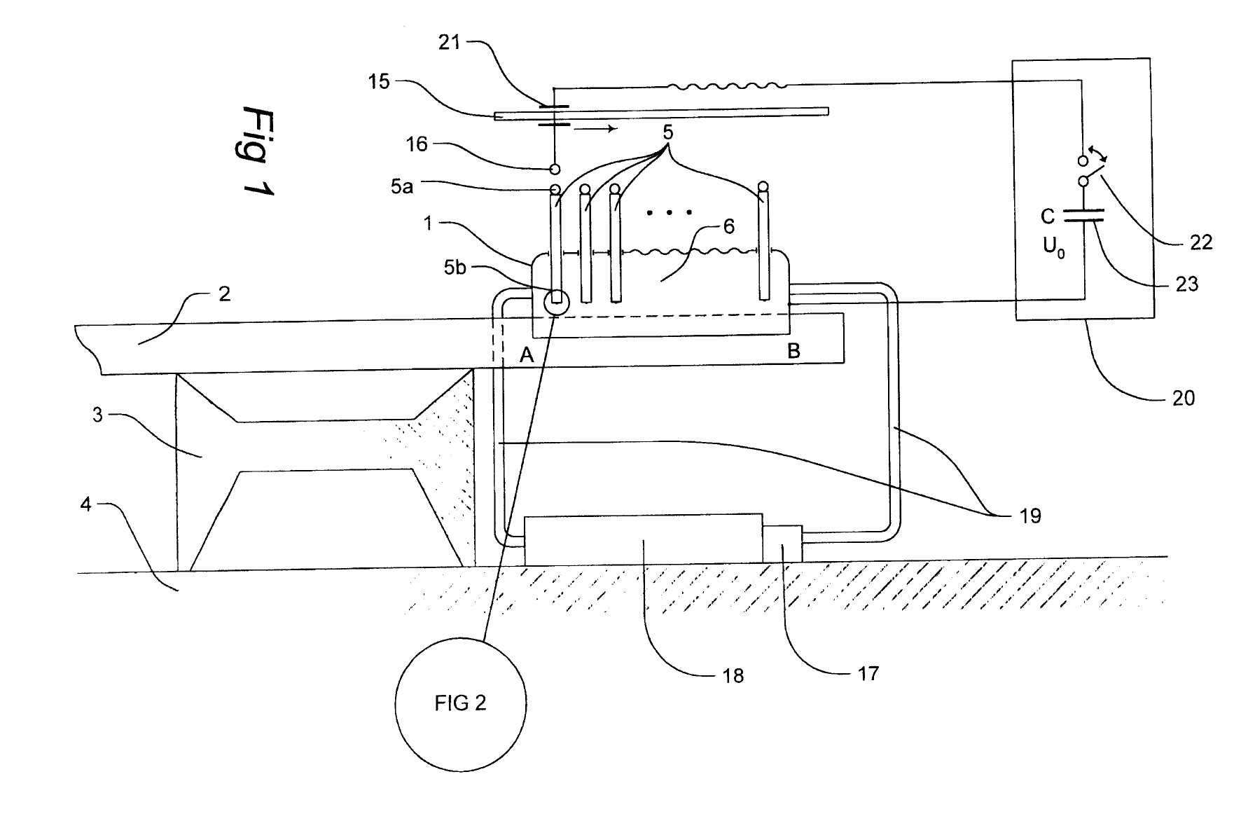

FIG. 1 is a schematic illustration of an apparatus according to the preferred embodiment for providing an identity marking on an object 2. In FIG. 1 the object 2 is illustrated as a steel pipe. However, as already mentioned, the invention is equally applicable to various other types of objects made of an electrically conductive material with crystalline structure.

The steel pipe 2 is placed on a support 3, which in turn rests on the ground or floor 4. A marking chamber 1 is placed on top of the steel pipe 2 along a portion of its external surface. The bottom of the marking chamber 1 is curved in correspondence with the curved surface of the steel pipe 2, so as to rest safely on the steel pipe 2. Advantageously, there are also provided external fastening means for securing the marking chamber 1 to the steel pipe 2.

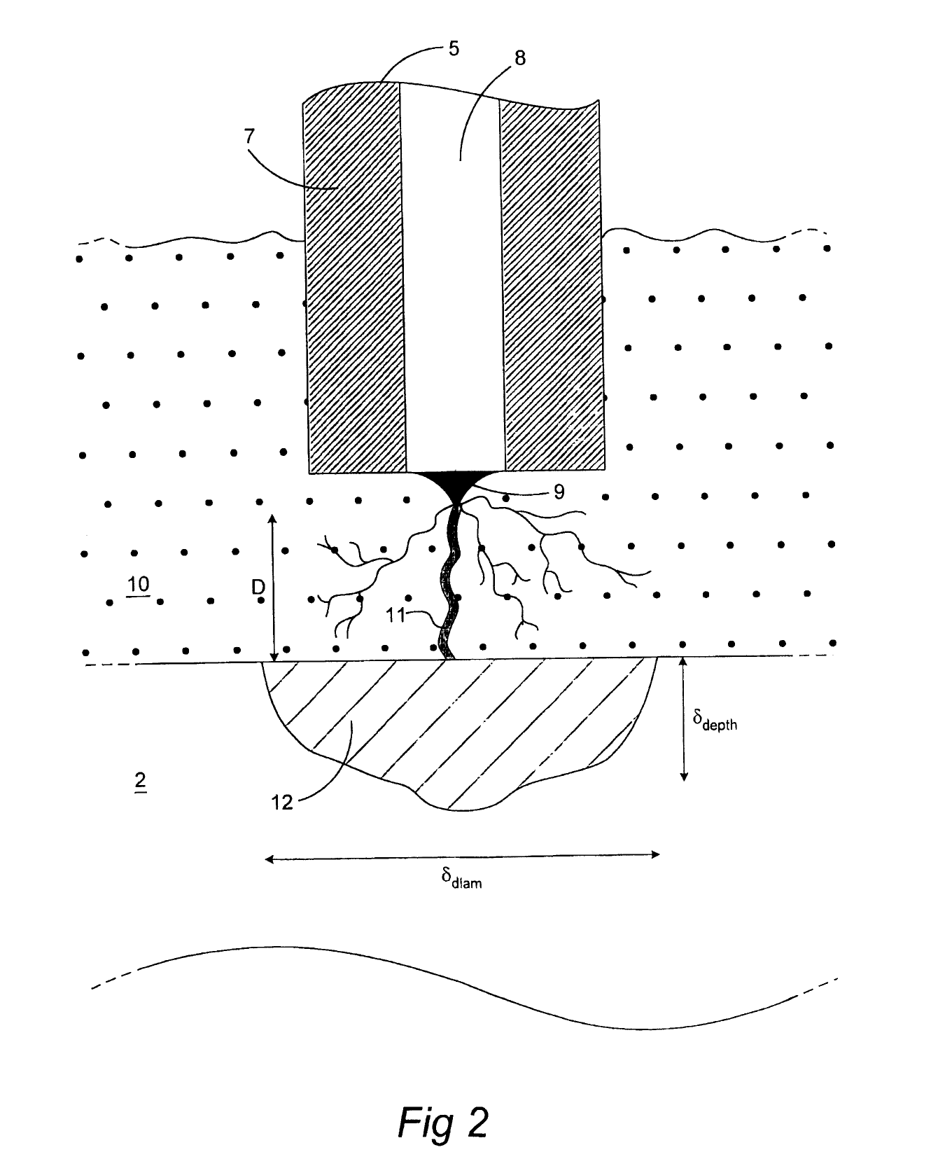

A plurality of marking electrodes 5 are inserted partly into the interior of the marking chamber 1 through respective openings in the top surface of the chamber 1. As will be described in more detail below, each electrode will act, when driven by a high-voltage electrical impulse, to generate a plasma channel into the surface region of the steel pipe 2. The plasma channel will locally modify the material structure of the steel pipe 2, as indicated in the form of a modified zone 12 in FIG. 2, and these modified zones will constitute the identity marking of the pipe.

Each electrode 5 has an upper end 5a and a lower end 5b, the latter of which will be positioned with only a small distance from the surface of the steel pipe 2, as is illustrated in more detail in FIG. 2. The upper end Sa is adapted to establish momentary electrical connection with a movable contact 16, which is slidably mounted, at 21 in FIG. 1, to a linear guide 15. In turn, the movable contact 16 is connected to an electrical impulse generator 20. Under control from an electrode controller arrangement not disclosed in the drawings, the movable contact 16 will be moved in a preprogrammed sequence between the respective upper ends 5a of the different electrodes 5 in order to apply a respective electrical impulse onto the surface region of the steel pipe 2.

The electrical impulse generator 20 comprises a member 23, such as a capacitor, capable of accumulating electrical energy to be used for the generation of the electrical impulse through the electrode 5. It also comprises a discharge switch 22, which in an open position Will allow the capacitor 23 to accumulate electrical energy as supplied from an external power supply not disclosed in the drawing. When the discharge switch 22 is closed, the accumulated electrical energy will be rapidly discharged from the capacitor 23 and will be delivered through the movable contact 16 to one of the electrodes 5, as will be described in more detail below. To this end, the electrical impulse generator 20 will act as cathode, through the movable contact 16 and the electrode 5, whereas the surface of the steel pipe 2 will act as anode, through the housing of marking chamber 1 and an electrical wiring to the other side of the capacitor 23 in the electrical impulse generator 20. The electrical impulse generator 20 as such is no essential part of the present invention. It may be implemented by any of various different commercially available equipment, and a detailed description of its internal parts is omitted herein.

A tank 18 and a pump 17 are adapted to supply a working fluid 10 (see FIG. 2), through conduits 19, to the marking chamber 1. The purpose of the working fluid 10 is to conduct the electrical impulse generated by the electrical impulse generator 20 from the lower end Sb of the electrode 5 to a local surface region 12 of the steel pipe 2. As will be described in more detail below, the working fluid must have electrically conductive properties, but apart from this various different liquids may be used as working fluid. Plain tap water, oil, an inert gas or a salt solution are only a few conceivable examples of working fluids. The amount of working fluid inside the marking chamber 1 is not particularly critical, as long as it fully covers the surface of the steel pipe 2 as well as the lower ends 5b of the electrodes 5. Upon generation of the electrical impulse, a considerable reaction force will be applied to the connection between the electrode 5 in question and the top of the marking chamber 1. Consequently, each electrode 5 is securely mounted through each respective opening into the marking chamber 1. Moreover, all electrodes 5 are located at least a certain minimum distance from the interior wall of the marking chamber 1, so that the electrical impulse will not be attracted to the interior wall of the marking chamber but will instead be directed at the surface region of the steel pipe 2. About 4 cm has been found to be an appropriate minimum distance between the interior wall of the marking chamber 1 and the nearest electrode 5.

FIG. 2 illustrates the lower portion 5b of an electrode 5 in detail, together with the working fluid 10 and the surface region of the steel pipe 2. The electrode 5 has an isolating coating 7 and a conductive core 8, which ends in an electrode tip 9. As seen in FIG. 2, the lower portion of the electrode 5 is fully surrounded by the working fluid 10. Moreover, the tip 9 of the electrode 5 is positioned a certain distance D from the surface of the steel pipe 2. The actual value of the distance D must be selected after due consideration of several application parameters, such as the voltage U₀ of the electrical impulse, the properties of the working fluid 10 and the material of the steel pipe 2. The distance D may be as large as 80-100 mm for a voltage U₀ of 40-50 kV. In such a case, the surface area of the modified zone will typically be 2-3 mm². If, on the other hand, the distance D between the tip 9 of the electrode 5 and the steel pipe 2 is considerably smaller, such as D=5-10 mm, the surface area of the modified zone 12 could be about 2-2.5 cm².

When the electrical impulse is supplied from the generator 20 through the electrode 5, a channel 11 of electrical plasma will be formed from the tip 9 of the electrode 5 through the working fluid 10 and will enter as energy into the surface region of the steel pipe 2. Thus, a local region of the steel pipe 2 will be rapidly heated by the plasma channel 11, and this will be followed by a rapid cooling of the aforesaid local region due to the working fluid 10. The speed of the impulse heating of the local surface region of the steel pipe 2 may amount to 50-1,000×10⁵ K/second, and the speed of cooling may be 20-1,000×10³ K/second. The density of electrical energy supplied by the plasma channel 11 to the local surface region of the steel pipe 2 may be 40-1,100×10⁸ W/m².

At the local surface region 12 where the electrical plasma 11 has reached the steel pipe 2, the material structure will be locally changed. The diameter γ_{diam} and the penetration depth δ_{depth} of the modified zone 12 will depend on, inter alia, the type and size of the electrode 5, the distance D, the material of the steel pipe 2 as well as the characteristics of the electrical impulse. For instance, the diameter δ_{diam} may be 5-20 mm, and the penetration depth δ_{depth} may be of the order of 100 μm-1 cm or even deeper.

Particulars about a channel of electrical plasma generated in a conductive material in response to an applied electrical impulse are found in GB-1,429,464 (entitled “Creating high pressures in liquids”), U.S. Pat. No. 3,997,468 (entitled “Method of creating high and super-high pressure and arrangement for disbursing non-metalliferous materials”) and GB-1,428,253 (entitled “Improvements relating to pipe cleaning”), all of which are fully incorporated herein by reference. Consequently, the present invention makes novel use of generation of an electrical plasma channel in a conductive material upon application of an electrical impulse. Generally, within the context of the present invention, the plasma channel generation process can be divided into three main stages.

In stage 1, electrical power in excess of a breakdown power threshold of the working media (working fluid 10) is accumulated on the cathode and ultimately reaches its maximum. A small electrical current starts to flow between the cathode and the anode during a short stage of delay.

Then, in stage 2, the small current, which started in stage 1, begins to form a channel between the cathode and the anode. The breakdown of the working media starts, when the power reaches its maximum, wherein a highly conductive channel starts to form. The power slightly decreases, and the electrical current increases, wherein the conductivity of the channel also increases during this stage.

Finally, in stage 3, all the accumulated power (except for the small fraction which was spent on creating the channel) is transformed from the cathode to the anode during a very short period of time (about 10-100 μs) . This is due to the high conductivity of the channel. The temperature of the substance of the channel increases up to (15-40)×10³ K, and the pressure increases to 300-1,000 MPa. The channel grows radially at a very high speed due to the increased internal pressure. The growing channel forces the working media to compress, thereby generating a counter pressure in the working media, which in turn will limit the radial growth of the channel. The local structural change of the anode material (i.e. the local zone 12 in the surface region of the steel pipe 2) is a result of the high energy, which is transferred through the plasma channel to the anode, as described above. As already mentioned, the local structural material change in the modified zone 12 will constitute a code element in the identity marking of the steel pipe 2.

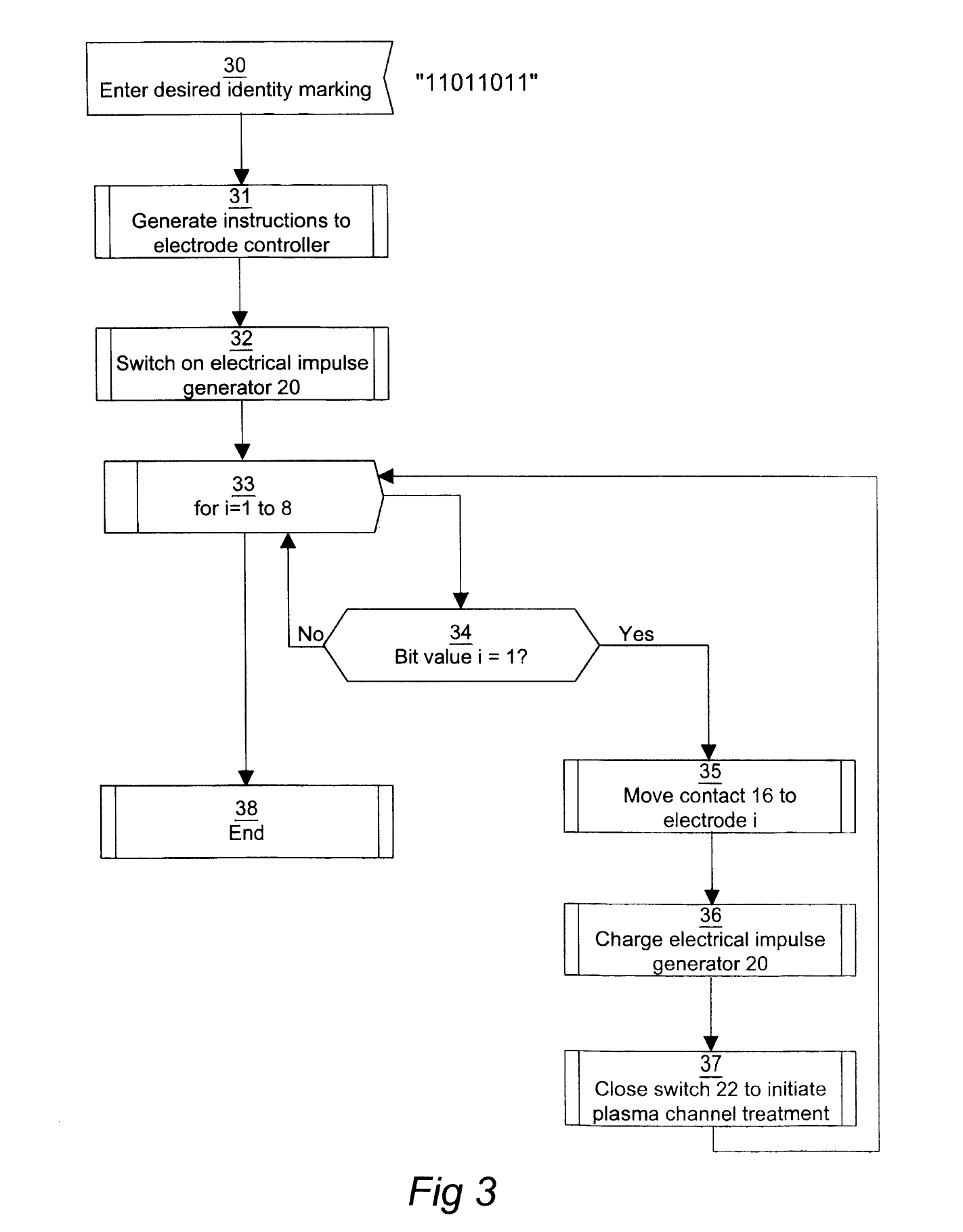

An overview of the operation method of the equipment shown in FIGS. 1 and 2 will now be illustrated with further reference to FIG. 3. In the following sections it is assumed that the steel pipe 2 is to be provided with a simple binary identity marking having a value of “11011011”. In practice, such a short identity marking has a limited usability, since it can only represent one out of 256 different code values. In a real-life application, a considerably larger number of code positions (binary digits) will be used for the identity marking, as is readily realized by a man skilled in the art. Referring now to FIG. 3, in a first step 30 an operator of the identity marking equipment will enter the desired identity marking (i.e. “11011011” in this example) through appropriate input means, such as a computer keyboard. Next, the entered desired identity marking value will be read by the electrode controller (not shown in the drawings), which in a step 31 will generate control instructions as regards which of the individual electrodes 5 that are to be activated in order to generate a respective binary value in the desired identity marking. In the present example, a binary “1” will be represented by a modified zone 12 on the steel pipe 2, whereas a binary “0” will be represented by an unmodified zone. Consequently, in this case the electrode controller will conclude that electrodes No. 1, 2, 4, 5, 7 and 8 will have to be activated in sequence, so as to generate the desired identity marking “11011011”.

No details are given herein as regards the implementation of the electrode controller, since virtually any commercially available industrial controller equipment can be used for this purpose. Consequently, choosing and programming an appropriate controller equipment for the purpose of exercising the invention described in this document is believed to be well within reach of a person skilled in the art.

Next, in a step 32, the operator will switch on the electrical impulse generator 20 by e.g. actuating a main power switch not disclosed in the drawing. Then, as indicated in steps 33-37, the electrode controller will execute a loop for as many times as there are binary digits in the entered desired identity marking. Hence, since the desired identity marking used in this example contains 8 binary digits, the loop 33 will be iterated 8 times, as indicated in FIG. 3.

In a step 34, the electrode controller will determine whether a respective one of the bit positions 1-8 in the entered desired identity marking value is equal to 1. If this is the case, the execution continues to a step 35, where the movable contact 16 is transferred along the linear guide 15 to the respective electrode 5, so as to allow electrical contact between the electrode and the electrical impulse generator 20. Next, the electrical impulse generator 20, and more specifically the capacitor 23 contained therein, will be charged in a step 36. When the capacitor 23 has been fully charged in step 36, the switch 22 will be closed in a step 37 so as to apply an electrical impulse to the respective electrode 5, wherein the plasma channel treatment described above will be performed and a local surface region 12 with a changed material structure will be formed on the steel pipe 2 as a representation of the individual bit value i.

Upon completion of step 37, the execution will return to step 33, so as to allow another iteration of the loop, provided that i has not reached a value of 8. i will be incremented each time step 37 has been completed, until i equals 9. Then, the loop 33-37 will not be performed anymore, and instead the procedure will end in a final step 38.

If the decision in step 34 is that the respective bit value i is not equal to 1 (i.e. is equal to 0), then steps 35-37 will not be performed. Instead, the execution will immediately return to the introductory step 33 of the loop. Hence, in this case no electrical impulse will be applied to the individual electrode 5 in question, and as a result the corresponding local surface region on the steel pipe 2 below the electrode 5 in question will be left unmodified as a representation of a binary value 0.

For steel constructions the change in material structure, caused by the electrical impulse and the plasma channel, will include a considerable strengthening (hardening) of the local surface region, to which the electrical impulse is applied. In addition, the changed material structure may include a change in chemical composition and/or mechanical properties other than hardness, as will be described in more detail with reference to a plurality of test results later in this section. A general feature is that the modified zone 12 with its locally changed material structure will be permanent and will not cause any damage to the marked object 2 or any deterioration in its properties.

Below is a table of three typical industrial types of steel, which have been tested in conjunction with the present invention.

| | Chemical composition | | | | | | |
|---|---|---|---|---|---|---|---|
| | | | | | | S, % | P, % |
| | | | | | | no more | no more |
| Name | C, % | Si, % | Mn, % | Cr, % | Ni, % | than | than |
| Steel1 | 0.42- | 0.17- | 0.50- | 0.25 | 0.25 | 0.040 | 0.040 |
| | 0.50 | 0.37 | 0.80 | | | | |
| Steel2 | 0.11- | 0.80 | 0.80 | 16.0- | 1.50- | 0.025 | 0.025 |
| | 0.17 | | | 18.0 | 2.50 | | |
| Steel3 | 0.14- | 0.17- | 0.25- | 1.35- | 4.00- | 0.025 | 0.025 |
| | 0.20 | 0.20 | 0.55 | 1.65 | 4.40 | | |

The penetration depth δ_{depth} of the zone 12 with changed material structure will typically be 90-200 μm for Steel1, 30-200 μm for Steel1 and 40-350 μm for Steel3. However, additional tests have proven that the change in material structure will in some cases penetrate much deeper than these values. Conclusively, both the diameter δ_{diam} of the modified zone 12 and its penetration depth δ_{depth} will depend on various factors, such as the magnitude of the electrical impulse, the type and properties of the steel material, the geometry of the electrode and the characteristics of the working fluid.

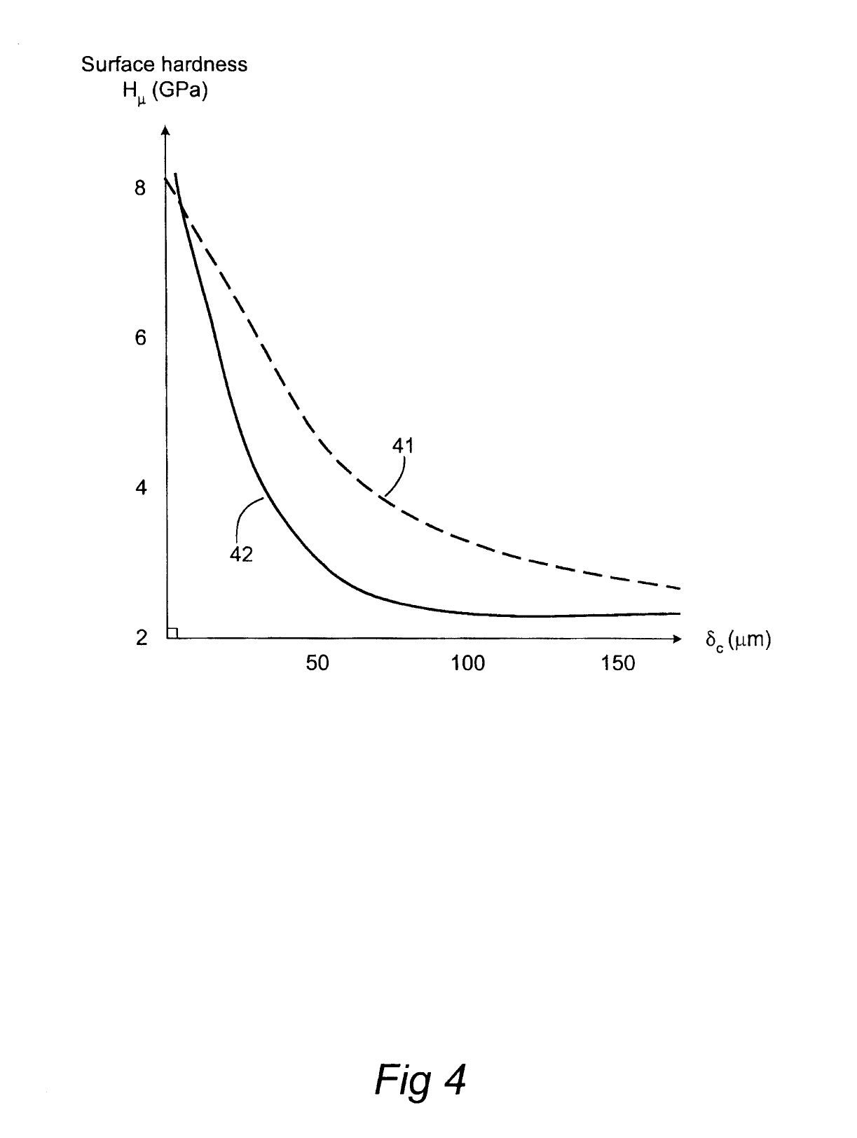

Various tests have been performed for the above and other types of steel, as will be described further below with reference to FIGS. 4-7.

### 1. Visual Effect

For an observer, the visual part of the modified zone 12 will appear like a circle. Around the modified zone 12 there may be seen a set of concentric circles of iridescence, which appear due to the changes of temperature of heating around the plasma channel. The surface roughness of the affected zone was found to be R_{z}=60-100 μm for all investigated types of steel.

### 2. Surface Hardness (Grain Structure)

Microscopic investigations have shown that there will be an amorphous or fine-grained “white layer” at the surface level of the material. The white layer is a result of the simultaneous heat impulse and impact impulse. The hardness of the white layer will typically be 1.5-3.5 times the hardness of an unmodified material. Moreover, under the white layer there will be an additional layer, where the grains are smaller than in the white layer. FIG. 4 illustrates the surface hardness H_{μ} after plasma channel treatment for Steel1 (dashed line 41) and Steel1 (solid line 42). γ_{c} in FIG. 4 represents the depth of the modified zone (corresponding to the penetration depth δ_{depth} in FIG. 2).

Moreover, the white layer of Steel1 is thicker than for Steel1. This could be explained by a larger percentage of carbon in Steel1. Presence of nickel also contributes to the generation of the white layer, because nickel will accelerate the process of dissolving carbides in austenite. There have been found some grains of ferrite in the low carbon steels after plasma channel treatment. This confirms that an α [symbol] γ transformation occurs without diffusion, as a result of the very rapid heating and cooling processes. As regards Steel1 (base material ferrite-perlite), electronic microscope investigations have indicated that the white layer thereof can be identified as martensite and residual austenite, as well as carbides (Cr, Fe)₂₃C₆.

### 3. Residual Stress

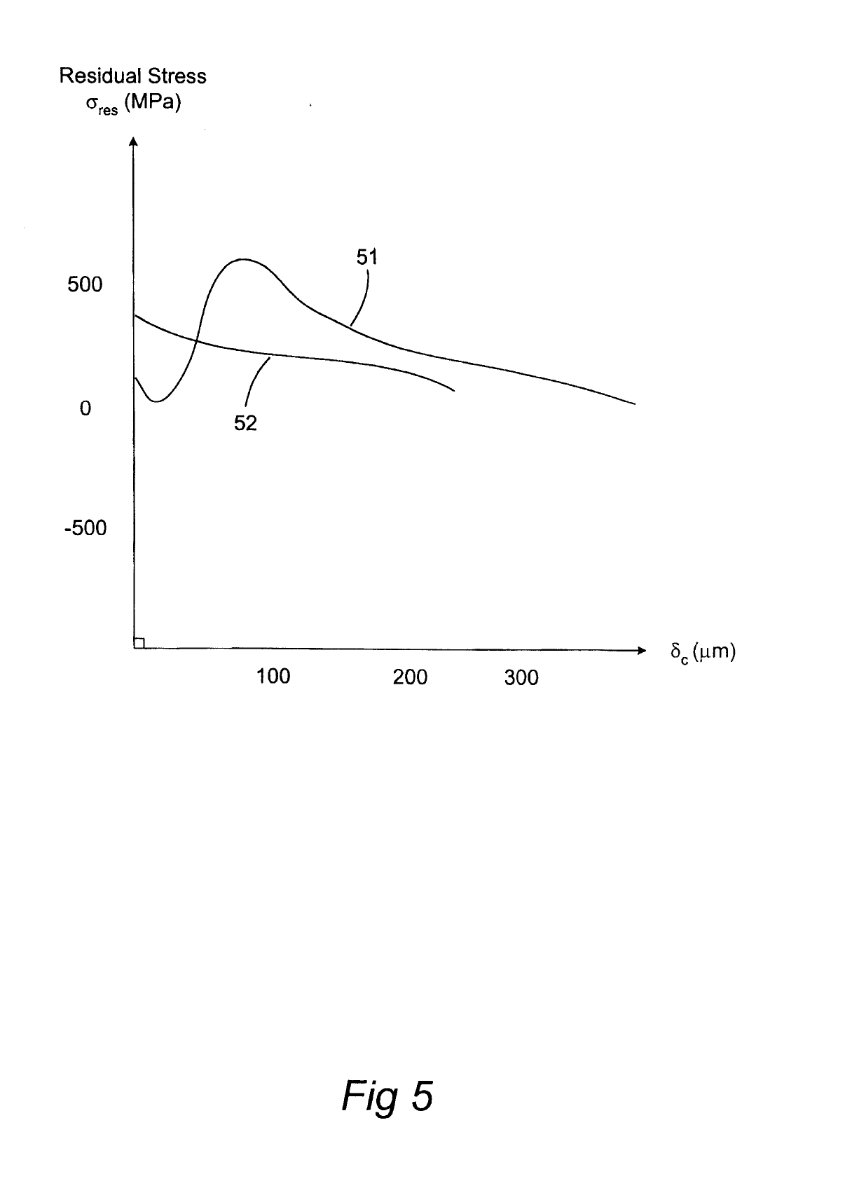

FIG. 5 illustrates the residual stress σᵣₑₛ for steel with 4% carbon and 1% chrome (line 51), and for steel with 14% carbon and 17% chrome (line 52). The parameters of the electrical impulse used for the test were U₀=30 kV and C=12 μF.

FIG. 5 reveals the tensile residual stress on the surface and the compressive residual stress at a depth of 400 μm for line 51, which is below aforesaid white layer. The compressive residual stress for line 52 starts at a depth of 200 μm.

### 4. Micro Deformations

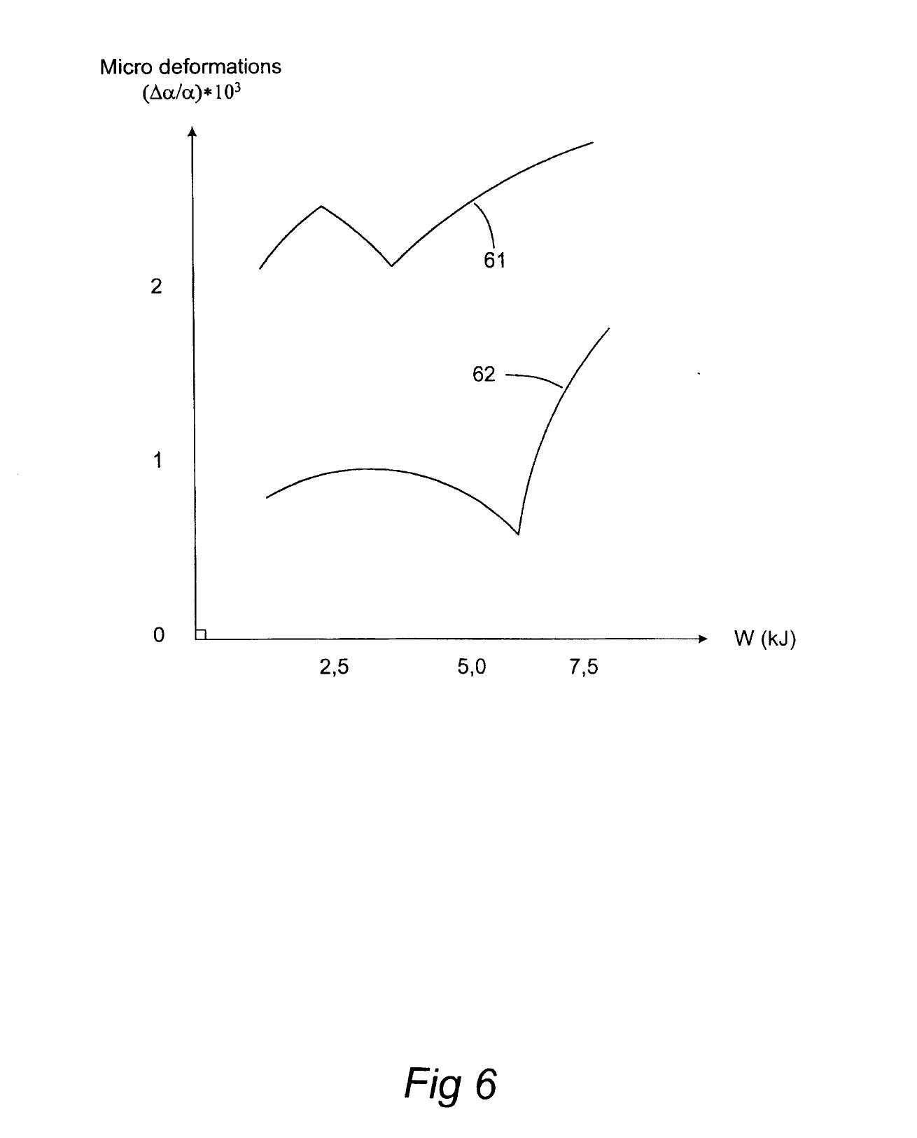

FIG. 6 illustrates the results of investigations of micro deformations in the material after plasma channel treatment. In FIG. 6, line 61 represents a steel with 4% carbon and 1% chrome, whereas line 62 represents Steel1 in the above table. The micro deformations were determined by evaluating the distribution of micro stress by measuring deformations in different layers of a material sample. The measurements were done layer by layer, and each layer was removed by etching. A stain gauge was used to measure the deformations in the layers. Residual stress on the main axes was calculated from the deformations with the following assumptions:

The surface stress of a material sample does not exceed the yield limit.

The surface stress of a material sample is evenly distributed.

Surface forces are statically balanced.

The border effect propagates by the distance, which is not longer than the width of the material sample.

The following formula was used to calculate the residual stress on the main axes:

σᵣₑₛ=−B_{σ}(dε/d_{δ}_{ᵢ})+∫A_{δ}_{ᵢ₋₁}(dε/d_{δ}_{ᵢ₋₁})dδᵢ₋₁,

where B₉₄ and A_{δ}_{ᵢ} are factors, which depend on the thickness of the removed layer, ε is the deformation and γᵢ is the thickness of the removed layer i, where i=1, 2, 3, . . .

The thickness of a removed layer δᵢ is defined by measuring the loss of material per time unit (the speed of etching):

δᵢ=R[1−(G₁/G₂)],

where R is the width of the material sample before etching, G₁ is the weight of the material sample after etching, and G₂ is the weight of the material sample before etching.

The residual stress distribution data is the average measurement results for three or more material samples.

Additionally, micro stress was also investigated by a radio graphical method generally known as the Debye-Scherrer method. The residual stress in a marked zone 12 is a result of local plastic deformations, phase transformations and uneven heating and cooling of the material. Basically, the radio graphical method involves analyzing the residual stress by measuring the change Δ [symbol] of the diffraction pattern. In the simplest case, the normal stress σ is coupled to the diffraction pattern change Δ [symbol] by the following equation:

σ=Ε·(cos [symbol] /sin [symbol] )·(Δ [symbol] /μ),

where Ε is the Young's modulus and μ is the Poisson ratio. The micro stress results in broadening of the diffraction lines. The micro stress was evaluated by changes and broadening of the diffraction lines by the standard procedure.

### 5. Cracking Resistance

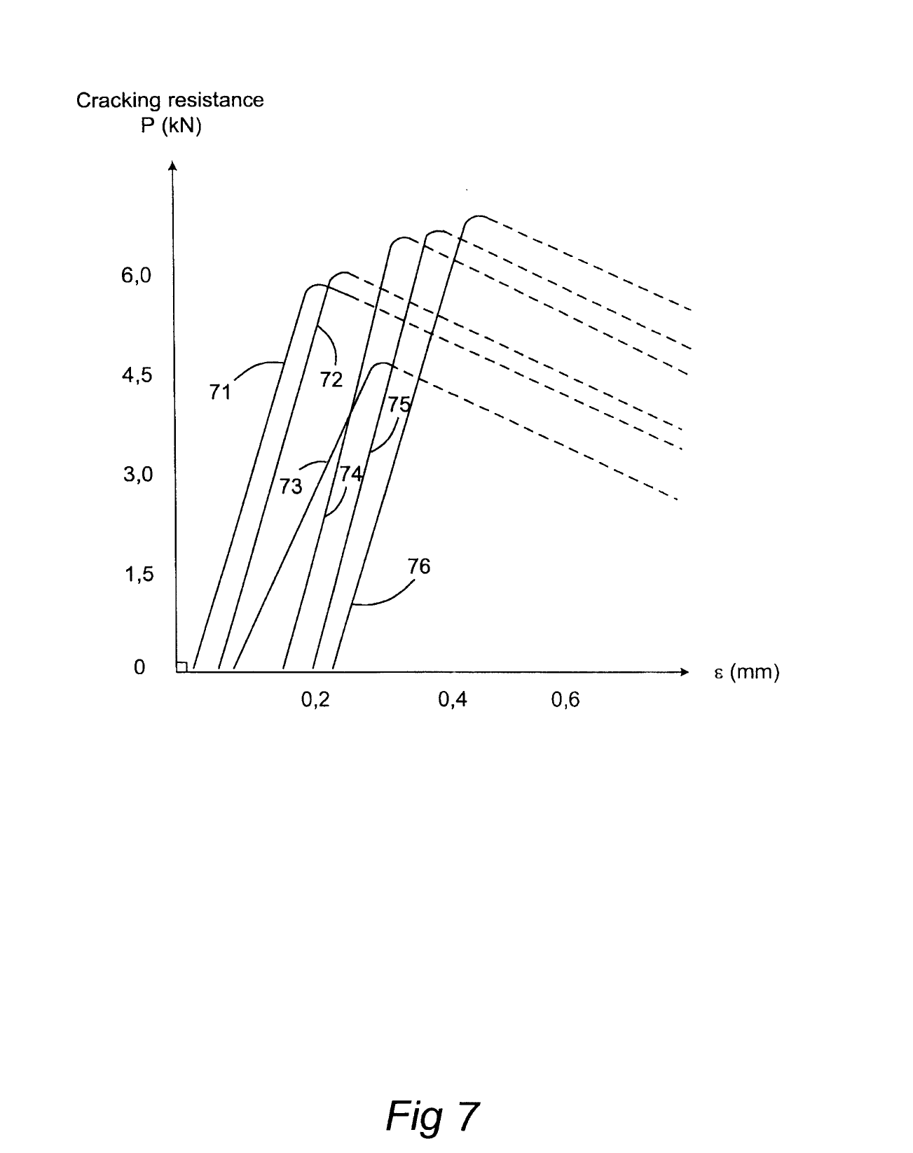

FIG. 7 illustrates the result of measurements on the cracking resistance, as evaluated by the critical stress intensity factor. Bars with rectangular cross section (18 by 10 mm) were bended with a static load at a speed of 0.6 m/s. Opening of cracks was registered by tensometers. Lines 71, 72 and 73 represent a steel with 4% carbon and 1% chrome, where no plasma channel treatment was applied. Correspondingly, lines 74, 75 and 76 represent material samples of the same steel, which were treated by a plasma channel.

### 6. Wear Resistance

An abrasion test arrangement involving a spinning wheel and a stationary block (generally known as a MI-1M type of machine) was used for testing wear resistance. The speed of the wheel was v_{F}=0.89 m/s, and a force P_{F}=0.3-0.4 MPa was applied to the block for testing friction without lubricant. 0.1% of quartz sand was added to a standard industrial oil for an abrasive lubricant friction test. Here the speed was v_{F}=0.89 m/s, and the applied force P_{F}=2.0-3.9 MPa. The wear was evaluated from the loss of weight from each sample. These experiments indicated that the plasma treatment increases the wear resistance of the material. The table below indicates the loss of weight (in mg) of Steel1 during frictional engagement between the steel sample and pig iron with and without lubricant and before and after plasma channel treatment, respectively:

| | Friction | | Lubricant | | Friction | | Lubricant | |
|---|---|---|---|---|---|---|---|---|
| | without | | with | | without | | with | |
| | lubricant | | abrasives | | lubricant | | abrasives | |
| | Wheel | block | wheel | block | wheel | block | wheel | block |
| Before | 240 mg | 630 mg | 180 mg | 56 mg | 420 mg | 550 mg | 220 mg | 230 mg |
| After | 140 mg | 390 mg | 80 mg | 28 mg | 320 mg | 350 mg | 180 mg | 80 mg |

Investigations of other types of steel have indicated that the wear resistance factor increases about 1.5-2.5 times after plasma channel treatment.

In addition to changing the material structure of the material, as described in the above embodiments, it is also possible, within the scope of the invention, to change the chemical composition of the material. For instance, for some steel materials, the zones under treatment can absorb alloying elements from the environment during the plasma channel process, due to accelerated diffusion in the material and an active transfer of chemical elements into the material. Changing also the chemical composition of the material may increase contrast and durability of the identity marking.

For steels with low carbon contents one option is to insert a very small piece of wire with a high content of manganese or nickel-chromium steel, or some other type of alloy, in front of the electrode 5. This will allow a local alloying process in the zone 12. The thin wire, having a diameter of e.g. 0.05-0.15 mm, will quickly be evaporated by the electrical impulse and enter a plasma state. Active alloying elements from the metallic plasma will then be transferred into the steel structure during the contact of plasma with its juvenile surfaces. This explosion of the thin wire will occur in the working fluid 10 and will produce a plasma with a density up to 0.01 g/cm² and a temperature of about 20-35×1 K. Such plasma has a high ionization degree, is very active and is aggressive in the interaction with the steel material.

Alternatively, the chemical composition of the material may be achieved according to the following. A thin layer (1 μm) of isotopes Fe55, Fe59 with OD 12 mm is applied on the surface of the material through an electrochemical reaction. The thin layer of isotopes would be placed at predefined positions according to the desired pattern of the identity marking. The samples with the pattern of isotopes should be submerged under water. Two marking electrodes (anode and cathode) will be positioned above the surface of the sample and will face each other in order to prevent direct contact between the plasma and the isotope layer during discharge. The distance from the electrodes to the surface of the sample should be 1.5 times longer than the distance between the electrodes.

After the electrical impulse generator has been turned on and electrical impulses have been generated between the pair of electrodes, the pair of electrodes may advantageously be slowly moved along the marking back and forth a few times.

The residual integration of isotopes into the metal surface of the samples have been analyzed layer-by-layer (in steps of 0.3-0.7 μm). It was concluded that the minimum integration depth of the radioactive isotope Fe⁵⁵⁺⁵⁹ is about 20 μm.

Such a transfer of mass cannot be the result of a mix of two components in the solid state, because the integration depth would then only be of the order of 0.1 μm. The interstitial atoms are assumed to bring the largest contribution to the process. The weak radioactivity of each marking zone will make it easily recognizable by the use of existing standard equipment. The above confirms that it is possible to excess the maximum rate of integration in a solid state and to add an alloying element to the material in order to create a new alloy in a local surface region according to a predefined specification.

Yet another example of the above will now be given. A result of ultra-high speed of the thermal cycle (heating and cooling) during the electrical impulse is an intense grinding of the initial structure. This increases a number of crystal defects (at the border of grains and blocks) as well as the dislocation density, which promotes diffusion processes. An electrical impulse generates a pressure impact on the surface of the material, in addition to the thermal factor, and this activates dislocation movement. Dislocation density is also increased. Thus, the process of diffusion is accelerated by a dislocation process in metals. The electrical plasma activates these processes during the electrical impulse. Consequently, by such processes of fast diffusion the chemical composition of the material may be changed in a local surface region, representing a part of an identity marking. It can be achieved by a transfer of alloying elements into the local zone from the working media. An active chemical component in a working media will saturate the surface layer of the material. Salts of alloying metals dissolved in water can be used for this purpose For instance, a water solution of chloride of chromium will increase the content of chromium in a surface layer of samples made up of steel L-80 with as much as 450%, if such a solution is used instead of plain water. Moreover, usage of another liquid is possible. A transformer oil (macromolecular hydrocarbon) will increase the content of carbon in a surface layer of samples made of steel L-80 with as much as 400%.

Presumably, the juvenile surfaces generated by the electrical plasma will act as catalysts for diffusing atoms from the working media into the material under treatment. Results from experimental investigations confirm the opportunity to use the above-described electrical impulse method for alloying of steel surfaces and for predefining the chemical characteristics of the new alloy by manipulating the working media.

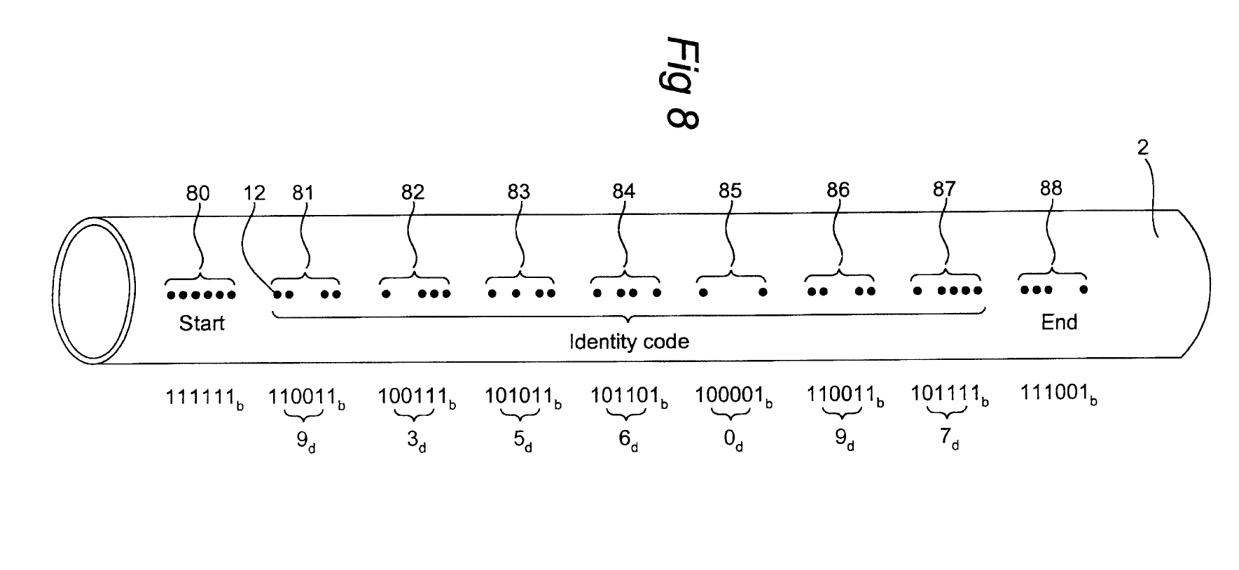

FIG. 8 gives another and more realistic example of a type of identity marking provided on a steel pipe 2 according to the present invention. In FIG. 8, it is assumed that the operator wants to mark the steel pipe 2 with the decimal value “9356097”, representing e.g. an article number or serial number of the steel pipe 2, its producer, its owner, etc. In FIG. 8, each decimal digit in the identity code is represented by a respective set of six binary digits 81-87, i.e. a binary sextette. Thus, the entire identity code (which contains seven decimal digits) will be formed by the seven binary sextettes 81-87, each of which will contain six binary digits corresponding to the respective decimal value. Each of these binary digits is represented by a local surface region 12 with modified material structure, as has been described thoroughly with reference to the preceding drawings, if the binary digit in question is equal to 1. If on the other hand the respective binary digit is equal to 0, then the corresponding local surface region on the steel pipe 2 will not be exposed to any plasma channel treatment and, consequently, the material structure thereof will be left unmodified.

In order to facilitate subsequent reading of the identity marking 81-87, each binary sextette always starts with a binary 1 and always ends with a binary 1. In effect, the information represented by each binary sextette is therefore constituted by the four intermediate binary digits between the first and the last binary 1, as shown in FIG. 8. For instance, the first decimal digit in the identity marking, i.e. 9, is represented by the binary sextette 81 in FIG. 8, which starts and ends with binary 1's and contains the binary value “1001” in between. As is well-known in the technical field, the binary value “1001” is equal to the decimal value 9.

Moreover, in order to improve the reading of the identity marking, the identity code may preferably be preceded by a separate start sextette 80, which always will have the binary value “111111”. Correspondingly, the identity code will always be finished by an end sextette 88, which will always have the binary value “111001”.

However, the examples of identity code formats indicated in FIGS. 3 and 8 only represent a few examples among a virtually unlimited number of possible code formats. Moreover, even if a binary identity code format at least presently appears to be a practical approach, the present invention also envisages identity code formats which are based on non-binary number systems. For instance, by making use of the alloying feature described above with reference to some embodiments (i.e. where not only the material structure but also the chemical composition of the material is changed), it will be possible to use another base than 2 (binary) as number system for the identity code. In such a case, a first type of chemical composition in the resulting modified zone may represent a first number in the number system, whereas a second chemical composition will represent a second number, etc.

As regards the arrangement of the individual electrodes 5, the present invention is clearly not limited to the examples given above. The number, distance, and arrangement of the set of electrodes 5 may be varied, essentially without limits, within the invention depending on an actual application. Also, instead of using a plurality of electrodes 5, it is equally possible to use just one electrode 5, which is moved between the respective identity code positions so as to create the respective local markings.

Finally, it is again emphasized that the invention is in no way limited to steel materials or pipes. Virtually any object of an electrically conductive material with crystalline structure can in principle be provided with an identity marking according to the invention.

The present invention has been described above with reference to some embodiments. However, other embodiments than the ones referred to above are equally possible within the scope of invention, which is best defined by the appended independent claims.

1. A method for providing an identity marking (81-87) on an object (2) made of an electrically conductive material with crystalline structure, characterized by the steps of
selecting at least one area (12) on a surface of the object (2);
for the or each selected area:
positioning an electrode (5) in proximity with the selected area;
supplying a fluid (10) between the electrode and the selected area; and
generating an electrical impulse between the electrode and the selected area through the fluid;
wherein a structural material change occurs locally at the or each selected area (12) and wherein the identity marking (81-87) of the object is represented by the or each selected area with its structural material change.

2. A method as in claim 1, wherein the object (2) is made of metal.

3. A method as in claim 2, wherein the object (2) is made of a steel material.

4. A method as in any preceding claim, wherein the object (2) is a pipe.

5. A method as in any preceding claim, wherein the structural material change at the or each selected area (12) is characterized by an increase in strength or hardness.

6. A method as in any preceding claim, comprising the further step of providing an alloying element between the electrode (5) and the selected area (12) prior to generating the electrical impulse, wherein at least a part of the alloying element will be absorbed by the object (2) and a local change in chemical composition will occur at the or each selected area (12).

7. A method as in any preceding claim, wherein the working fluid is a liquid with conductive properties.

8. A method as in claim 7, wherein the fluid (10) is water.

9. A method as in claim 7, wherein the fluid (10) is a salt solution.

10. A method as in claim 7, wherein the fluid (10) is an oil.

11. A method as in claim 7, wherein the fluid (10) is an inert gas.

12. A method as in any preceding claim, wherein each selected area (12) represents a respective binary value in the identity marking (81-87).

13. An apparatus for providing an identity marking (81-87) on an object (2) made of an electrically conductive material with crystalline structure, characterized by:
a chamber (1) adapted to be mounted on a surface of the object (2) and adapted to contain an electrically conductive fluid (10);
an electrode (5) having an end (5b, 9) which is in contact with the fluid in the chamber; and
an electrical impulse generator (20) coupled to the electrode and adapted to supply an electrical impulse from the electrode through the fluid to a local area (12) on a surface of the object proximate to said end of the electrode, so as to cause a structural material change at the local area; wherein the identity marking (81-87) of the object is represented by this area with its structural material change.
